(19) United States
(12) Patent Application Publication
(10) Pub. No.: US 2011/0307660 A1
(43) Pub. Date: Dec. 15, 2011

(54) REDUNDANT ARRAY OF INDEPENDENT DISKS SYSTEM, METHOD FOR WRITING DATA INTO REDUNDANT ARRAY OF INDEPENDENT DISKS SYSTEM, AND METHOD AND SYSTEM FOR CREATING VIRTUAL DISK

(76) Inventor: Chien-Hung Yang, Taipei City (TW)

(21) Appl. No.: 12/855,684

(22) Filed: Aug. 12, 2010

Related U.S. Application Data
(60) Provisional application No. 61/354,692, filed on Jun. 14, 2010.

(51) Int. Cl. G06F 12/00

(52) U.S. Cl. 711/114; 711/E12.001

(57) ABSTRACT

A redundant array of independent disks (RAID) system stores data mapped to a virtual disk, where the virtual disk includes a plurality of virtual sub-disks. The RAID system includes a plurality of storage devices and a controller. The controller is electrically connected to the storage devices, and is utilized for configuring the storage devices into a plurality of zone stripes, where each storage device includes a plurality of zones, each zone stripe includes one zone of each of the storage devices, and each zone stripe stores data mapped to a portion of data of each of the virtual sub-disks.

### CROSS REFERENCE TO RELATED APPLICATIONS

This application claims the priority of U.S. Provisional Application No. 61/354,692, filed Jun. 14, 2010, which is included herein by reference in its entirety.

### BACKGROUND OF THE INVENTION

1. Field of the Invention

The present invention relates to a redundant array of independent disks (RAID) system, and more particularly, to a RAID system, a method for writing data into the RAID system and a system and a method for creating a virtual disk.

2. Description of the Prior Art

Please refer to FIG. 1. FIG. 1 is a diagram illustrating a prior art redundant array of independent disks (RAID) system 120. As shown in FIG. 1, the RAID system includes three physical disks 122, 124 and 126 which are configured into a plurality of stripes 130_1-130_M, and the data stored in these physical disks 122, 124 and 126 is mapped to a virtual disk 110 which has a plurality of successive data blocks DB1-DBN. In other words, the data in the data blocks DB1-DBN are sequentially written to the stripes 130_1-130_M to create the virtual disk 110. Because the principle and the detailed structure of the RAID system 120 are known by a person skilled in the art, further descriptions are omitted here.

When the RAID system 120 needs to be expanded—that is an additional physical disks 128 is added into the RAID system 120—the data stored in the physical disks 122, 124 and 126 need to be rearranged to make the RAID system 120 have the data allocation shown in FIG. 2 to create the virtual disk. The data moving and rearranging operations require a lot of time: taking each physical disk as 1 TB (terabyte) and data access speed as 80 MB/s as an example, it may take several hours to complete the data rearranging operations, causing serious inconvenience to the users.

### SUMMARY OF THE INVENTION

It is therefore an objective of the present invention to provide a RAID system that can shorten the time required for data moving and rearranging operations when an additional physical disk is added into the RAID system, to solve the above-mentioned problem.

According to one embodiment of the present invention, a redundant array of independent disks (RAID) system for storing data mapped to a virtual disk is disclosed, where the virtual disk includes a plurality of virtual sub-disks. The RAID system comprises a plurality of storage devices and a controller. The controller is electrically connected to the storage devices, and is utilized for configuring the storage devices into a plurality of zone stripes, where each storage device includes a plurality of zones, each zone stripe includes one zone of each of the storage devices, and each zone stripe stores data mapped to a portion of data of each of the virtual sub-disks.

According to another embodiment of the present invention, a method for writing data into a redundant array of independent disks (RAID) system is disclosed, where the RAID system comprises a plurality of storage devices, each storage device includes a plurality of zones, and the data is mapped to a virtual disk including a plurality of virtual sub-disks. The method comprises: configuring the storage devices into a plurality of zone stripes, wherein each of the zone stripes includes a zone of each of the storage devices; and writing a portion of data of each of the virtual sub-disks into a zone stripe of the zone stripes.

According to another embodiment of the present invention, a redundant array of independent disks (RAID) system for creating a virtual disk is disclosed. The RAID system comprises a plurality of storage devices and a controller, where each storage device includes a plurality of zones. The controller is electrically connected to the storage devices, and is utilized for configuring the storage devices into a plurality of zone stripes, where each of the zone stripes includes a zone of each of the storage devices, and each zone stripe includes a plurality of data blocks; allocating a first portion of data blocks of each of the zone stripes to form a first virtual sub-disk; allocating a second portion of data blocks of each of the zone stripes to form a second virtual sub-disk, where the second portion of data blocks are different from the first portion of data blocks; and creating the virtual disk according to at least the first virtual sub-disk and the second virtual sub-disk.

According to another embodiment of the present invention, a method for creating a virtual disk on a redundant array of independent disks (RAID) system is disclosed, where the RAID system comprises a plurality of storage devices, and each storage device includes a plurality of zones. The method comprises: configuring the storage devices into a plurality of zone stripes, wherein each of the zone stripes includes a zone of each of the storage devices, and each zone stripe includes a plurality of data blocks; allocating a first portion of data blocks of each of the zone stripes to form a first virtual sub-disk; allocating a second portion of data blocks of each of the zone stripes to form a second virtual sub-disk, where the second portion of data blocks are different from the first portion of data blocks; and creating the virtual disk according to at least the first virtual sub-disk and the second virtual sub-disk.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a prior art RAID system.

FIG. 2 is a diagram illustrating the situation when an additional physical disk is added into the RAID system shown in FIG. 1 and how the data stored in the physical disks need to be rearranged to create the virtual disk.

FIG. 3 is a diagram illustrating a RAID system for creating a virtual disk and storing data mapped to a virtual disk according to one embodiment of the present invention.

FIG. 4 is a diagram of the virtual disk which is mapped to the physical disks shown in FIG. 3.

FIG. 5 is a data mapping relation between the virtual disk shown in FIG. 4 and the physical disks shown in FIG. 3.

FIG. 6 is a diagram illustrating a virtual disk when an additional physical disk is added into the RAID system shown in FIG. 3.

FIG. 7 is a diagram illustrating an expanded RAID system which has not rearranged the data stored therein.

FIG. 8 is a diagram illustrating how data of a zone stripe is rearranged.

FIG. 9 is a diagram illustrating a RAID system for creating a virtual disk and storing data mapped to a virtual disk according to another embodiment of the present invention.

FIG. 10 is a diagram of the virtual disk which is mapped to the physical disks shown in FIG. 9 when RAID 4 or RAID5 mode is adopted.

FIG. 11 is a data mapping relation between the virtual disk shown in FIG. 10 and the physical disks shown in FIG. 9 when RAID 4 mode is adopted.

FIG. 12 is a data mapping relation between the virtual disk shown in FIG. 10 and the physical disks shown in FIG. 9 when RAID 5 mode is adopted.

FIG. 13 is a diagram of the virtual disk which is mapped to the physical disks shown in FIG. 9 when RAID6 mode is adopted.

FIG. 14 is a data mapping relation between the virtual disk shown in FIG. 13 and the physical disks shown in FIG. 9 when RAID 6 mode is adopted.

FIG. 15 is a flowchart of a method for writing data into a RAID system comprising a plurality of storage devices according to one embodiment of the present invention.

FIG. 16 is a flowchart of a method for creating a virtual disk on a RAID system according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” The terms “couple” and “couples” are intended to mean either an indirect or a direct electrical connection. Thus, if a first device couples to a second device, that connection may be through a direct electrical connection, or through an indirect electrical connection via other devices and connections.

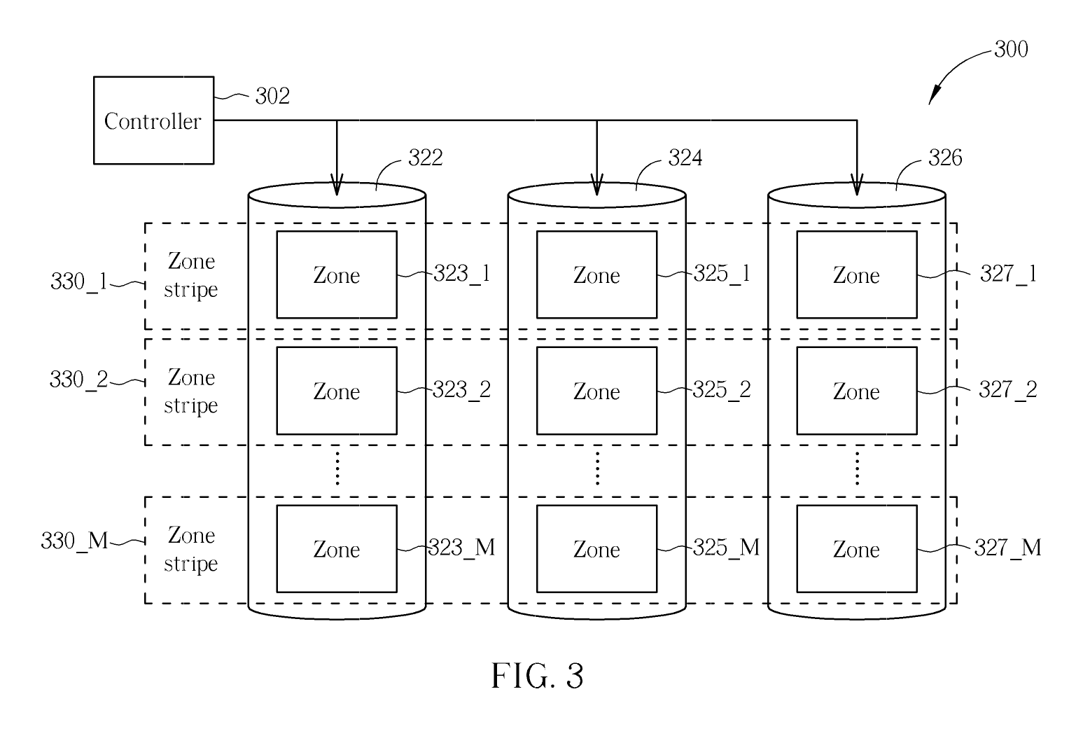

Please refer to FIG. 3. FIG. 3 is a diagram illustrating a redundant array of independent disks (RAID) system 300 for creating a virtual disk and storing data mapped to a virtual disk according to one embodiment of the present invention. As shown in FIG. 3, the RAID system 300 comprises a controller 302 and a plurality of storage devices (in this embodiment, three physical disks 322, 324 and 326 serve as an example, but not a limitation of the present invention). In this embodiment, the physical disks 322, 324 and 326 have the same effective size, and each of the physical disks 322, 324 and 326 are divided into a plurality of successive zones 323_1-323_M, 325_1-325_M and 327_1-327_M, respectively. The controller 302 configures the physical disks 322, 324 and 326 into a plurality of zone stripes 330_1-330_M, where each of the zone stripes 330_1-330_M includes one zone of each of the storage devices 322, 324 and 326. That is, the zone stripe 330_1 includes the zones 323_1, 325_1 and 327_1, the zone stripe 330_2 includes the zones 323_2, 325_2 and 327_2, . . . etc.

In addition, the physical disks in the RAID system 300 can be any type of disks such as IDE (Integrated Drive Electronics), SATA (Serial ATA), SCSI (Small Computer System Interface), SAS (Serial Attached SCSI), FC (Fiber channel) or SSD (Solid State Disk), etc.

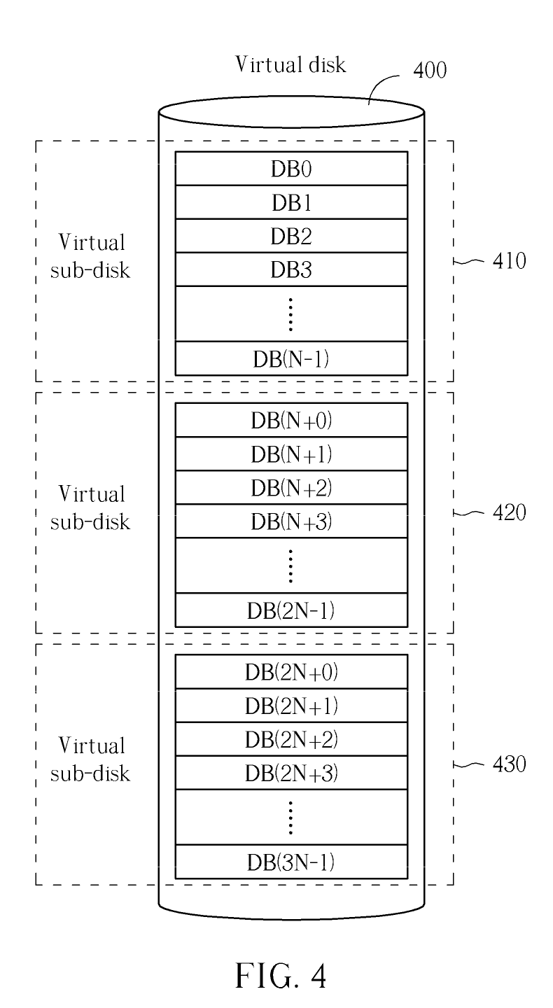

Please refer to FIG. 4. FIG. 4 is a diagram of the virtual disk 400 which is mapped to the physical disks 322, 324 and 326. As shown in FIG. 4, the virtual disk 400 has a plurality of successive data blocks DB0-DB(3N−1), and the virtual disk 400 is divided into three virtual sub-disks 410, 420 and 430, where a size of each of the virtual sub-disks 410, 420 and 430 is the same as the effective size of each of the physical disks 322, 324 and 326. In this embodiment, the virtual sub-disk 410 includes the data block DB0-DB(N−1), the virtual sub-disk 420 includes the data block DB(N+0)-DB(2N−1), and the virtual sub-disk 430 includes the data block DB(2N+0)-DB(3N−1).

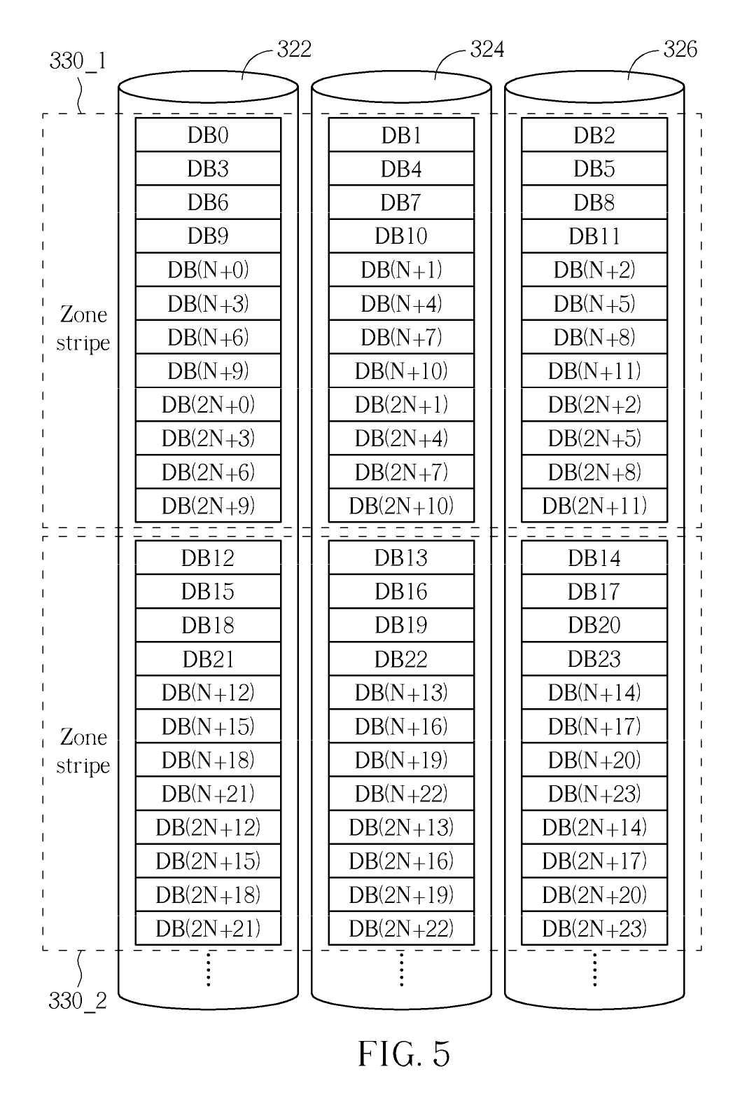

When the data mapped to the virtual disk 400 is written into the physical disks 322, 324 and 326, the data mapping relation between the virtual disk 400 and the physical disks 322, 324 and 326 can be shown in FIG. 4 and FIG. 5. Referring to FIGS. 4 and 5, the zone stripe 330_1 stores data mapped to a portion of data of each of the virtual sub-disks 410, 420 and 430: that is, the zone stripe 330_1 stores data which corresponds to data blocks DB0-DB11 of the virtual sub-disk 410, data blocks DB(N+0)-DB(N+11) of the virtual sub-disk 420 and data blocks DB(2N+0)-DB(2N+11) of the virtual sub-disk 430; the zone stripe 330_2 stores data mapped to another portion of data of each of the virtual sub-disks 410, 420 and 430: that is, the zone stripe 330_2 stores data which corresponds to data blocks DB12-DB23 of the virtual sub-disk 410, data blocks DB(N+12)-DB(N+23) of the virtual sub-disk 420 and data blocks DB(2N+12)-DB(2N+23) of the virtual sub-disk 430, . . . , and so on, such that each of the zone stripes 330_1-330_1 stores data mapped to a portion of data of each of the virtual sub-disks 410, 420 and 430.

Using another aspect to describe the data mapping relation between the virtual disk 400 and the physical disks 322, 324 and 326, the controller 302 configures the physical disks 322, 324 and 326 into a plurality of zone stripes 330_1-330_M, wherein each of the zone stripes 330_1-330_M includes a zone of each of the physical disks 322, 324 and 326, and each zone stripe includes a plurality of data blocks. Then, the controller 302 respectively allocates a portion of data blocks of each of the zone stripes to form the virtual sub-disks: that is, a first portion of data (DB0-DB(N−1)) stored in each of the zone stripes 330_1-330_M is allocated to form the virtual sub-disk 410, a second portion of data (DB(N+0)-DB(2N−1)) stored in each of the zone stripes 330_1-330_M is allocated to form the virtual sub-disk 420, and a third portion of data (DB(2N+0)-DB(3N−1)) stored in each of the zone stripes 330_1-330_M is allocated to form the virtual sub-disk 430. Finally, the controller 302 uses the virtual sub-disks to create the virtual disk 400.

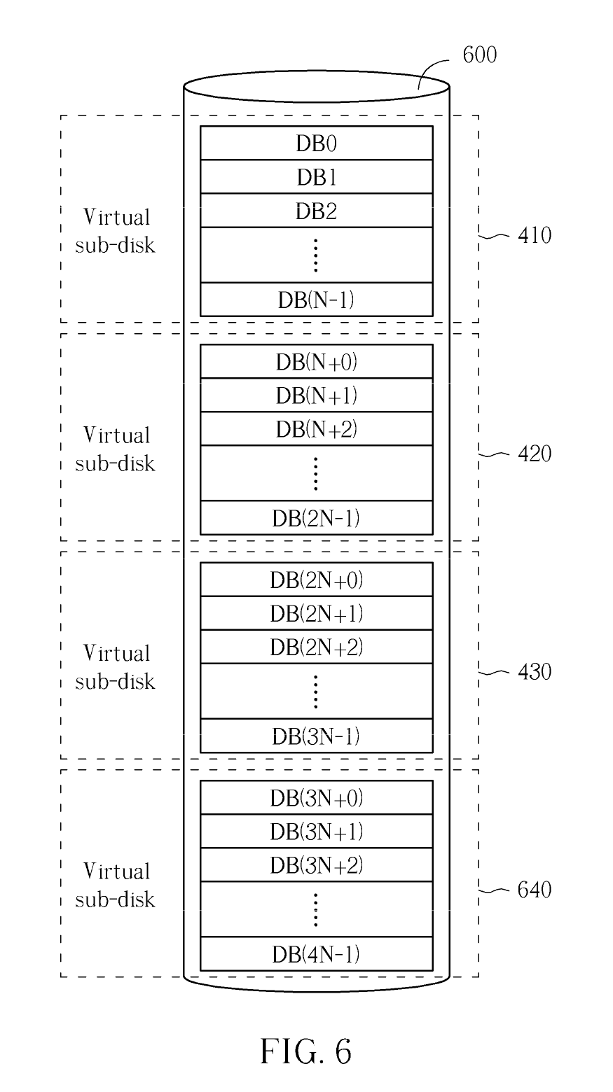

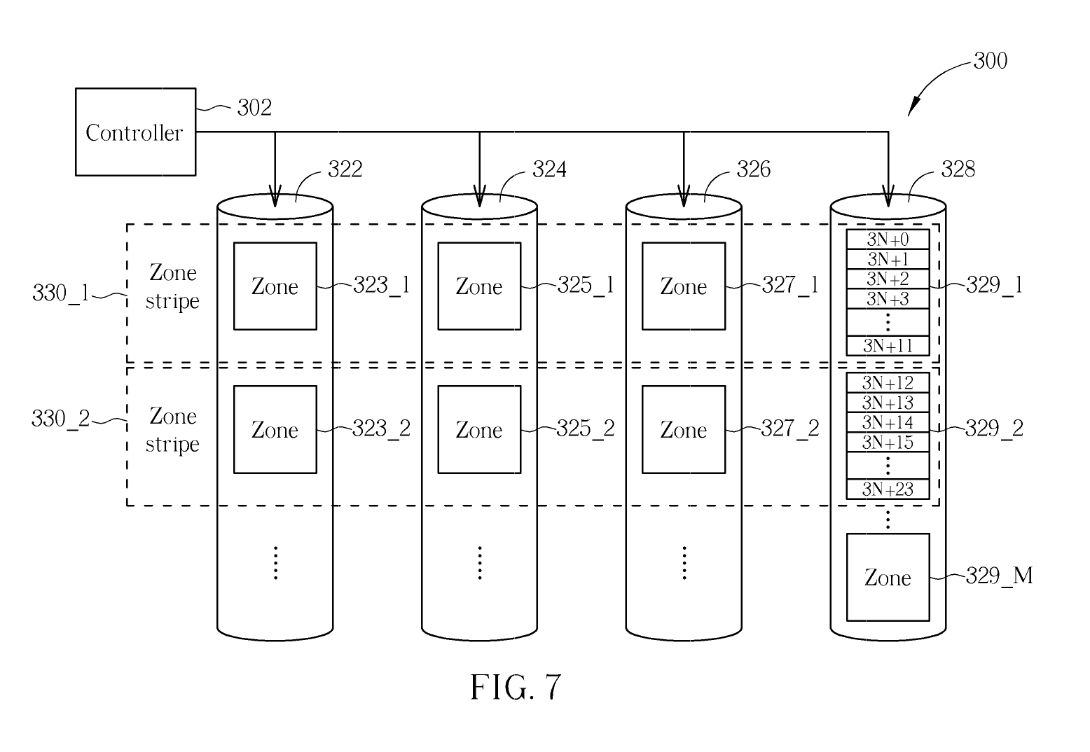

When the RAID system 300 needs to be expanded—that is at least an additional physical disk 328 which has the same effective size as each of the physical disks 322, 324 and 326 is added to the RAID system 300—the virtual disk 400 will expand to be an expanded virtual disk 600 which has 4N data blocks as shown in FIG. 6. The expanded virtual disk 600 includes the original virtual sub-disks 410, 420, 430 and a newly added virtual sub-disk 640, where the virtual sub-disk 640 includes data blocks DB(3N+0)-DB(4N−1). In addition, referring to FIG. 7 which illustrates an expanded RAID system 700 which has not rearranged the data stored therein, the additional physical disk 328 is divided into a plurality of successive zones 329_1-329_M, and each of the zones 329_1-329_M is used for storing data which is mapped to twelve data blocks of the virtual sub-disk 640.

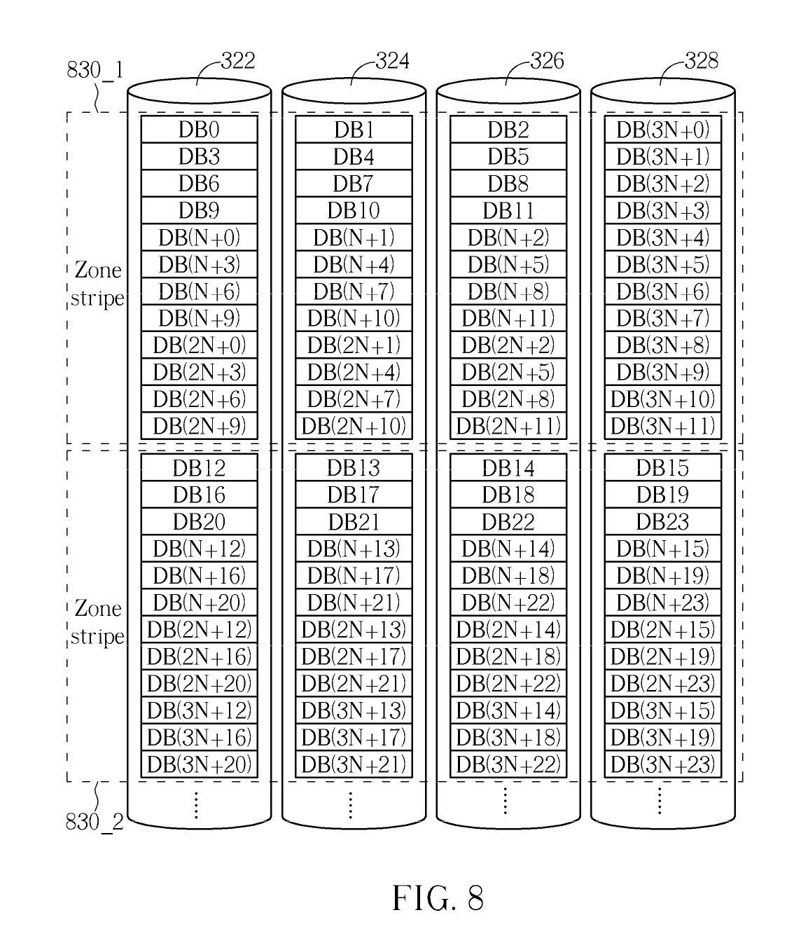

Then, the controller 302 configures the physical disks to make each zone stripe include one zone of each of the physical disks 322, 324, 326 and 328 as shown in FIG. 8. Then, for each zone stripe, the controller 302 can rearrange the data stored in the zone stripe without considering any other zone stripe of the RAID system; that is, the zone stripes are independent from each other. For example, if the data stored in the zone stripe 830_2 needs to be accessed, the controller 302 can only rearrange the data stored in the zone stripe 830_2 as shown in FIG. 8 and does not need to rearrange the data stored in any other zone stripes such as 830_1. Then, the other zone stripes can be rearranged later if necessary.

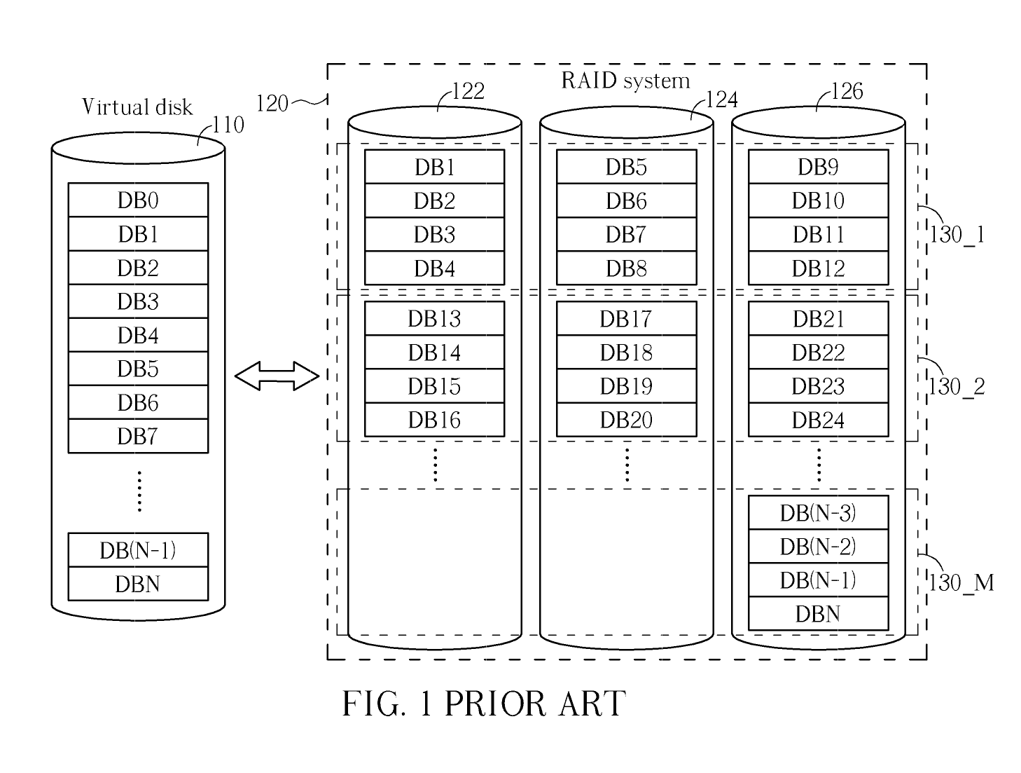

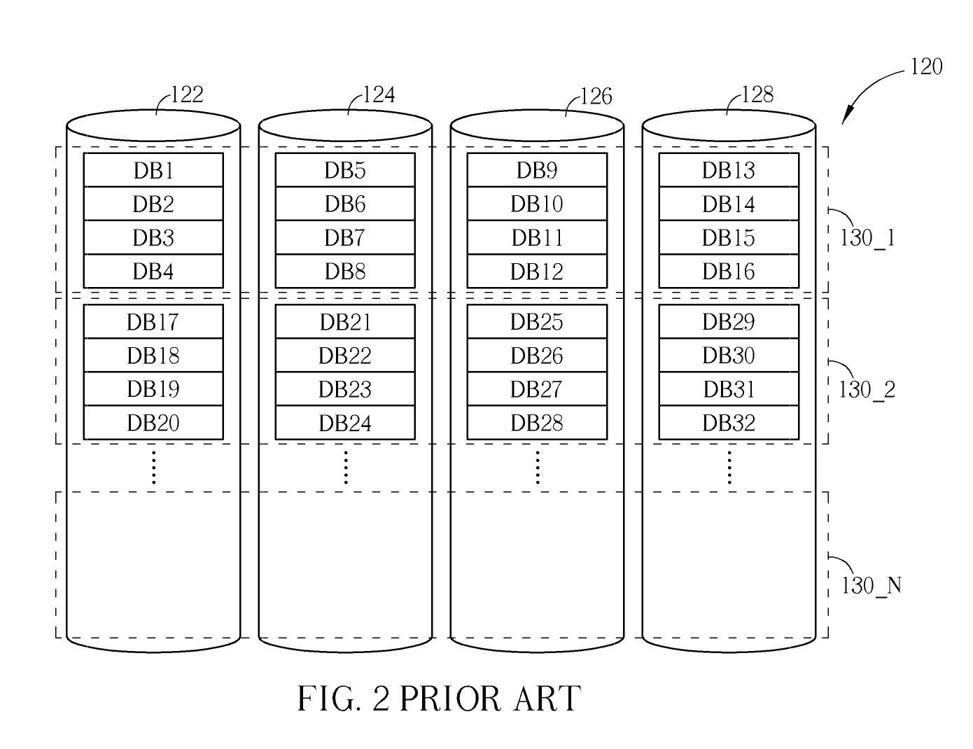

Therefore, when specific data stored in the physical disk needs to be accessed, only the data of the zone stripe storing the specific data needs to be rearranged, and this rearranging operation may merely need a few seconds to be completed. Compared with the prior art RAID 120 shown in FIG. 1 and FIG. 2, when an additional physical disk is added into the RAID system, all the data stored in the prior art RAID system 120 needs to be moved and rearranged so the data can be accessed normally, and this may take several hours. Therefore, it can be seen that the RAID system of the present invention greatly improves the prior art rearranging time issue.

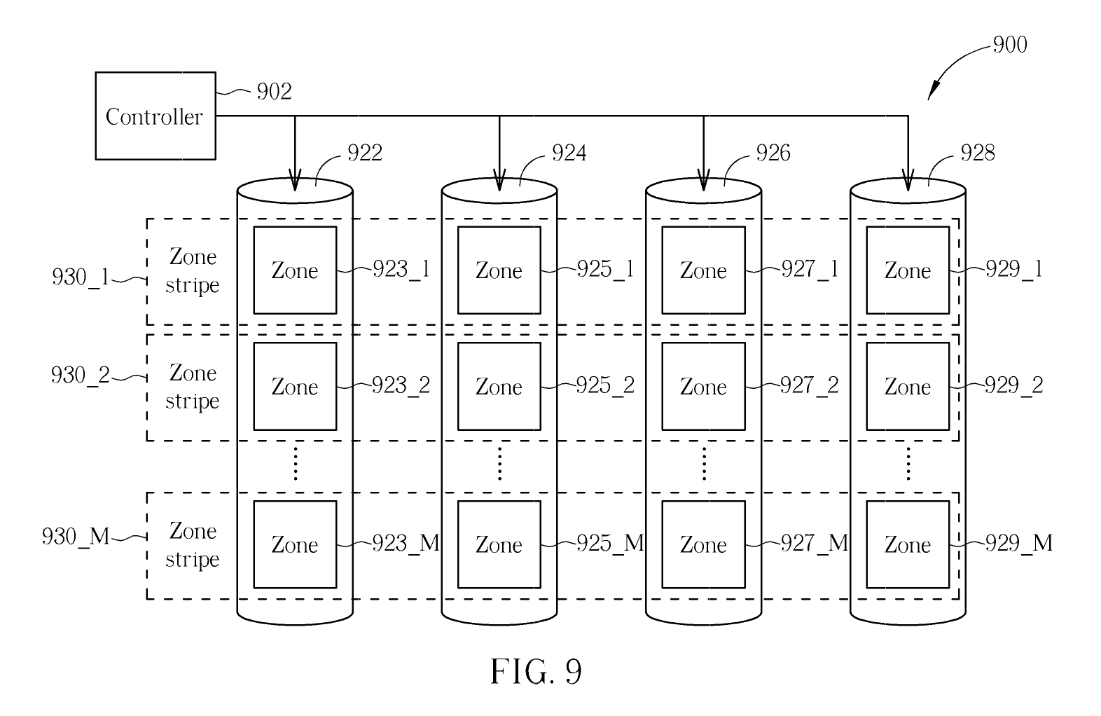

Please note that the above-mentioned RAID system 300 is under RAID0 mode. In other embodiments of the present invention, RAID systems with RAID4, RAID5 and RAID 6 modes are also provided. Please refer to FIG. 9. FIG. 9 is a diagram illustrating an RAID system 900 for creating a virtual disk and storing data mapped to a virtual disk according to another embodiment of the present invention. As shown in FIG. 9, the RAID system 900 comprises a controller 902 and a plurality of storage devices (in this embodiment, four physical disks 922, 924, 926 and 928 serve as an example, but not a limitation of the present invention). In this embodiment, the physical disks 922, 924, 926 and 928 have the same effective size, and each of the physical disks 922, 924, 926 and 928 are divided into a plurality of successive zones 923_1-923_M, 925_1-925_M, 927_1-927_M, and 929_1-929_M respectively. The controller 902 configures the physical disks 922, 924, 926 and 928 into a plurality of zone stripes 930_1-930_M, where each of the zone stripes 930_1-930_M includes one zone of each of the storage devices 922, 924, 926 and 928. That is, the zone stripe 930_1 includes the zones 923_1, 925_1, 927_1 and 929_1, the zone stripe 930_2 includes the zones 923_2, 925_2, 927_2 and 929_2, etc.

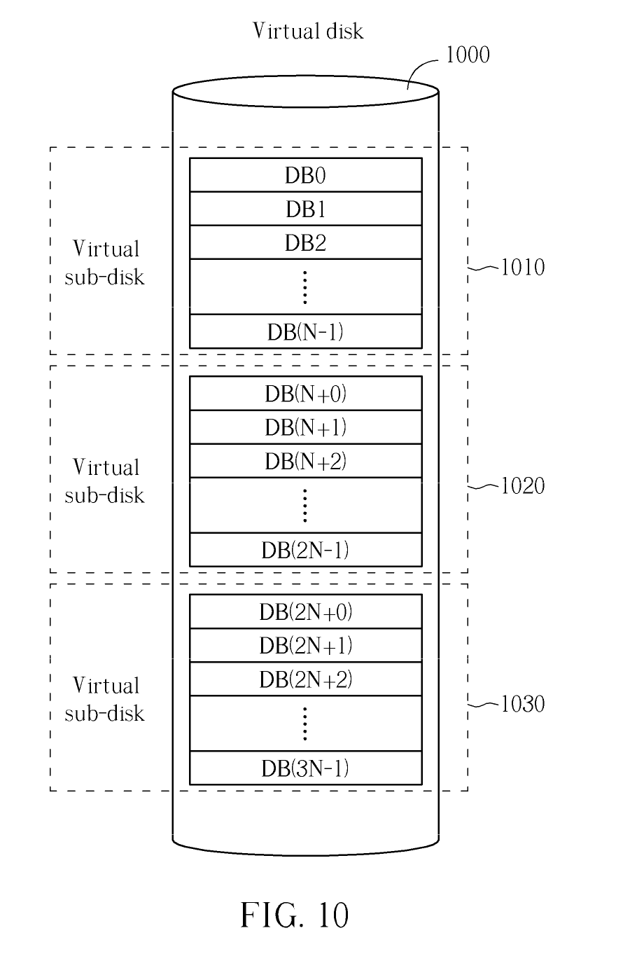

Please refer to FIG. 10. FIG. 10 is a diagram of the virtual disk 1000 which is mapped to the physical disks 922, 924, 926 and 928 when a RAID4 mode or RAID5 mode is adopted. The effective size in the virtual disk would not contain the parity size that is equivalent to a disk size. As shown in FIG. 10, the virtual disk 1000 has a plurality of successive data blocks DB0-DB(3N−1), and the virtual disk 1000 is divided into three virtual sub-disks 1010, 1020 and 1030, where a size of each of the virtual sub-disks 1010, 1020 and 1030 is the same as the effective size of each of the physical disks 922, 924, 926 and 928. In this embodiment, the virtual sub-disk 1010 includes the data block DB0-DB(N−1), the virtual sub-disk 1020 includes the data block DB(N+0)-DB(2N−1), and the virtual sub-disk 1030 includes the data block DB(2N+0)-DB(3N−1).

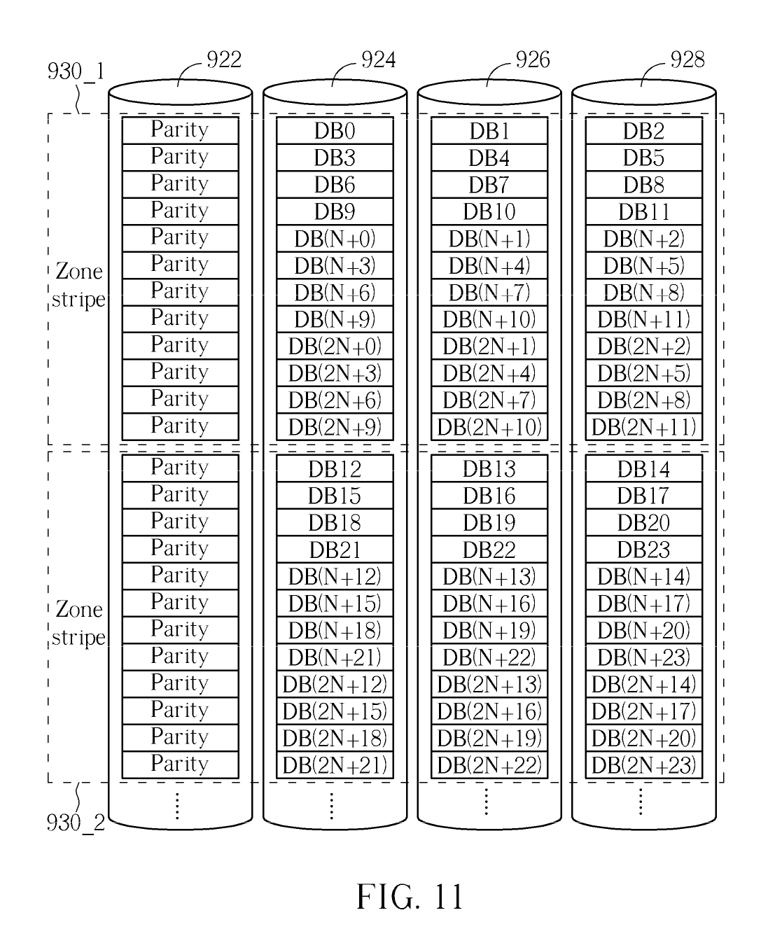

In one embodiment, when the data mapped to the virtual disk 1000 is written into the physical disks 922, 924, 926 and 928, the data mapping relation between the virtual disk 1000 and the physical disks 922, 924, 926 and 928 can be shown in FIG. 10 and FIG. 11 when the RAID 4 mode is adopted. Referring to FIGS. 10 and 11, the zone stripe 930_1 stores data mapped to a portion of data of each of the virtual sub-disks 1010, 1020 and 1030: that is, the zone stripe 930_1 stores data which corresponds to data blocks DB0-DB11 of the virtual sub-disk 1010, data blocks DB(N+0)-DB(N+11) of the virtual sub-disk 1020, data blocks DB(2N+0)-DB(2N+11) of the virtual sub-disk 1030 and their parity data of each line of data block; the zone stripe 930_2 stores data mapped to another portion of data of each of the virtual sub-disks 1010, 1020 and 1030: that is, the zone stripe 930_2 stores data which corresponds to data blocks DB12-DB23 of the virtual sub-disk 1010, data blocks DB(N+12)-DB(N+23) of the virtual sub-disk 1020, data blocks DB(2N+12)-DB(2N+23) of the virtual sub-disk 430 and their parity data of each line of data block, and so on.

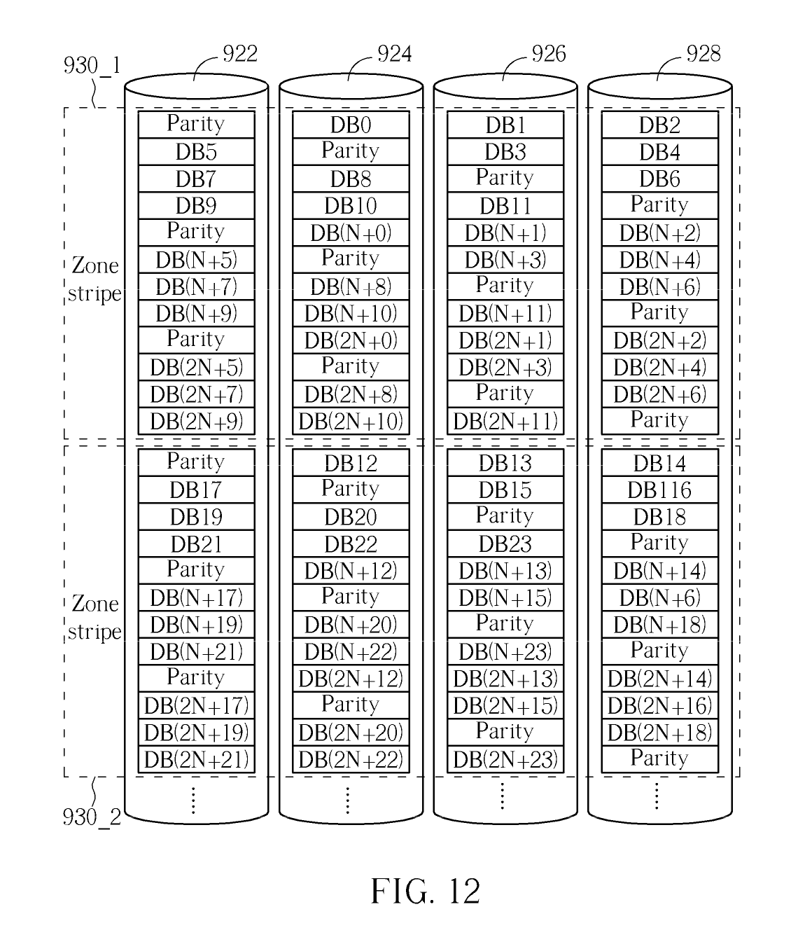

In another embodiment, when the data mapped to the virtual disk 1000 is written into the physical disks 922, 924, 926 and 928, the data mapping relation between the virtual disk 1000 and the physical disks 922, 924, 926 and 928 is shown in FIG. 10 and FIG. 12 when the RAID 5 mode is adopted. Referring to FIGS. 10 and 12, the zone stripe 930_1 stores data mapped to a portion of data of each of the virtual sub-disks 1010, 1020 and 1030: that is, the zone stripe 930_1 stores data which corresponds to data blocks DB0-DB11 of the virtual sub-disk 1010, data blocks DB(N+0)-DB(N+11) of the virtual sub-disk 1020, data blocks DB(2N+0)-DB(2N+11) of the virtual sub-disk 1030 and their parity data of each line of data block; the zone stripe 930_2 stores data mapped to another portion of data of each of the virtual sub-disks 1010, 1020 and 1030: that is, the zone stripe 930_2 stores data which corresponds to data blocks DB12-DB23 of the virtual sub-disk 1010, data blocks DB(N+12)-DB(N+23) of the virtual sub-disk 1020, data blocks DB(2N+12)-DB(2N+23) of the virtual sub-disk 430 and their parity data of each line of data block, and so on.

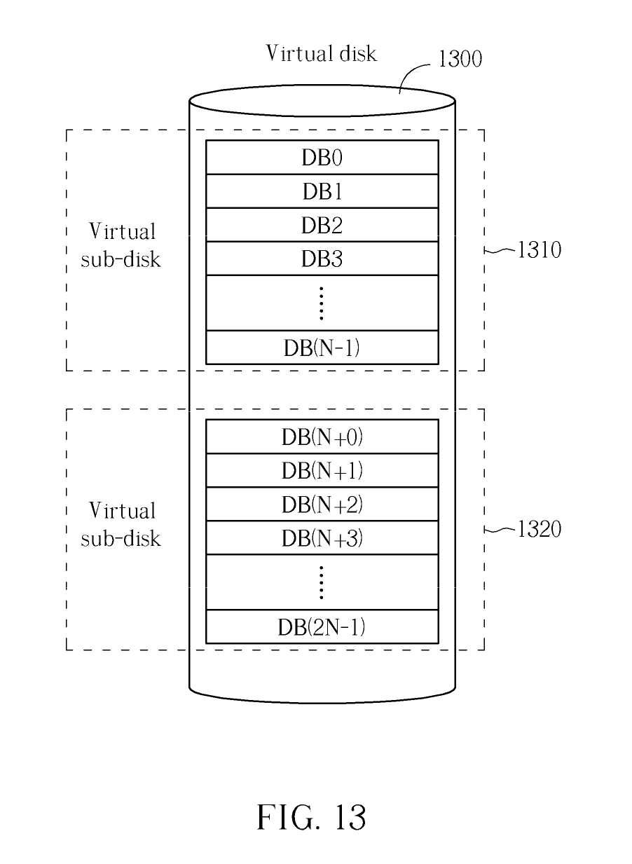

Please refer to FIG. 13. FIG. 13 is a diagram of a virtual disk 1300 which is mapped to the physical disks 922, 924, 926 and 928 when a RAID6 mode is adopted. The effective size in the virtual disk would not contain the parity size that is equivalent to two disks size. As shown in FIG. 13, the virtual disk 1300 has a plurality of successive data blocks DB0-DB(2N−1), and the virtual disk 1300 is divided into two virtual sub-disks 1310 and 1320, where a size of each of the virtual sub-disks 1310 and 1320 is the same as the effective size of each of the physical disks 922, 924, 926 and 928. In this embodiment, the virtual sub-disk 1310 includes the data block DB0-DB(N−1) and the virtual sub-disk 1320 includes the data block DB(N+0)-DB(2N−1).

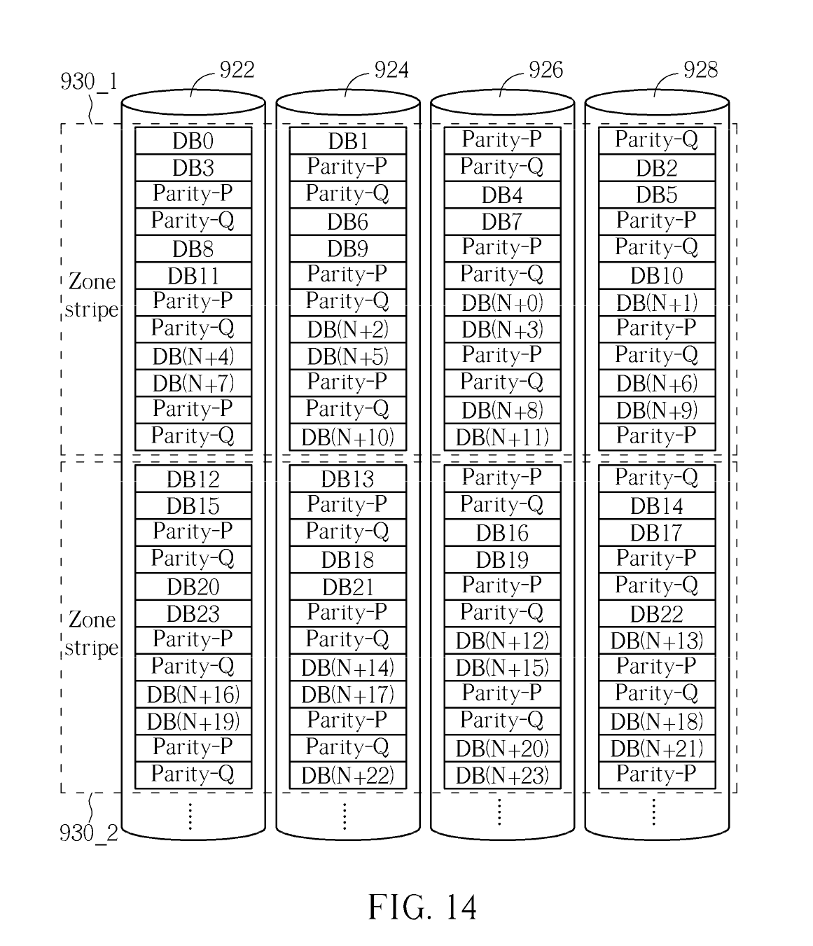

In one embodiment, when the data mapped to the virtual disk 1300 is written into the physical disks 922, 924, 926 and 928, the data mapping relation between the virtual disk 1300 and the physical disks 922, 924, 926 and 928 is shown in FIG. 13 and FIG. 14 when the RAID 6 mode is adopted. Referring to FIGS. 13 and 14, the zone stripe 930_1 stores data mapped to a portion of data of each of the virtual sub-disks 1310 and 1320: that is, the zone stripe 930_1 stores data which corresponds to data blocks DB0-DB11 of the virtual sub-disk 1310, data blocks DB(N+0)-DB(N+11) of the virtual sub-disk 1320 and their parity data Parity-P and Parity-Q of each line of data block; the zone stripe 930_2 stores data mapped to another portion of data of each of the virtual sub-disks 1310 and 1320: that is, the zone stripe 930_2 stores data which corresponds to data blocks DB12-DB23 of the virtual sub-disk 1310, data blocks DB(N+12)-DB(N+23) of the virtual sub-disk 1320, and their parity data Parity-P and Parity-Q of each line of data block, and so on.

Please note that the above-mentioned embodiments of the RAID system having RAID 0 mode, RAID 4 mode, RAID 5 mode and RAID 6 mode are for illustrative purposes only. As long as each zone stripe stores data mapped to a portion of data of each of the virtual sub-disks, any compound RAID or alternative design should fall within the scope of the present invention.

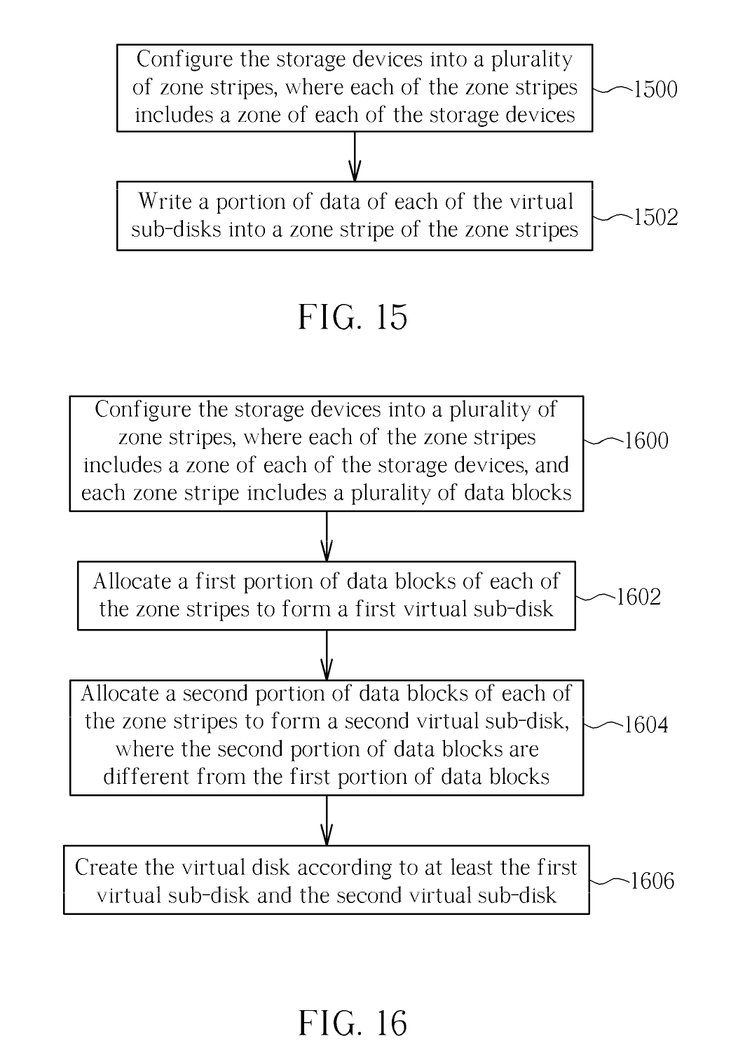

Please refer to FIG. 15. FIG. 15 is a flowchart of a method for writing data into a RAID system comprising a plurality of storage devices according to one embodiment of the present invention, where each storage device includes a plurality of zones, and the data is mapped to a virtual disk including a plurality of virtual sub-disks. Referring to FIG. 15, the flow is described as follows:

Step 1500: configure the storage devices into a plurality of zone stripes, where each of the zone stripes includes a zone of each of the storage devices.

Step 1502: write a portion of data of each of the virtual sub-disks into a zone stripe of the zone stripes.

Please refer to FIG. 16. FIG. 16 is a flowchart of a method for creating a virtual disk on a RAID system according to one embodiment of the present invention, where the RAID system comprises a plurality of storage devices, and each storage device includes a plurality of zones. Referring to FIG. 16, the flow is described as follows:

Step 1600: configure the storage devices into a plurality of zone stripes, where each of the zone stripes includes a zone of each of the storage devices, and each zone stripe includes a plurality of data blocks.

Step 1602: allocate a first portion of data blocks of each of the zone stripes to form a first virtual sub-disk;

Step 1604: allocate a second portion of data blocks of each of the zone stripes to form a second virtual sub-disk, where the second portion of data blocks are different from the first portion of data blocks.

Step 1606: create the virtual disk according to at least the first virtual sub-disk and the second virtual sub-disk.

Briefly summarized, in the present invention, the RAID system for storing data mapped to a virtual disk including a plurality of virtual sub-disks comprises a plurality of storage devices and a controller. The controller configures the storage devices into a plurality of zone stripes, where each storage device includes a plurality of zones, each zone stripe includes one zone of each of the storage devices, and each zone stripe stores data mapped to a portion of data of each of the virtual sub-disks. In the RAID system of the present invention, when an additional physical disk is added to the RAID system, the controller only needs to rearrange a portion of zone stripes which store the data required to be accessed. Therefore, the user can access the data immediately after the RAID system is expanded, and is thus more convenient.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A redundant array of independent disks (RAID) system for storing data mapped to a virtual disk, the virtual disk including a plurality of virtual sub-disks, the RAID system comprising:
a plurality of storage devices; and
a controller, electrically connected to the storage devices, for configuring the storage devices into a plurality of zone stripes, wherein each storage device includes a plurality of zones, each zone stripe includes one zone of each of the storage devices, and each zone stripe stores data mapped to a portion of data of each of the virtual sub-disks.

2. The RAID system of claim 1, wherein the storage devices are a plurality of physical disks, respectively.

3. The RAID system of claim 1, wherein the virtual sub-disks comprise at least a specific virtual sub-disk, the specific virtual sub-disk includes a plurality of contiguous data blocks, and data mapped to two successive data blocks of the contiguous data blocks of the specific virtual sub-disk are stored in different storage devices.

4. The RAID system of claim 1, wherein when at least an additional storage device is added to the RAID system, the controller rearranges the data stored in the zone stripe without considering any other zone stripe of the RAID system.

5. A method for writing data into a redundant array of independent disks (RAID) system comprising a plurality of storage devices, each storage device including a plurality of zones, the data being mapped to a virtual disk including a plurality of virtual sub-disks, the method comprising:
configuring the storage devices into a plurality of zone stripes, wherein each of the zone stripes includes a zone of each of the storage devices; and
writing a portion of data of each of the virtual sub-disks into a zone stripe of the zone stripes.

6. The method of claim 5, wherein the storage devices are a plurality of physical disks, respectively.

7. The method of claim 5, wherein the virtual sub-disks comprise at least a specific virtual sub-disk, the specific virtual sub-disk includes a plurality of contiguous data blocks, and the step of writing the portion of data comprises:
sequentially writing the contiguous data blocks into the storage devices to make data mapped to two successive data blocks of the contiguous data blocks of the specific virtual sub-disk be stored in different storage devices.

8. The method of claim 5, further comprising:
when at least an additional storage device is added to the RAID system, rearranging the data stored in the zone stripe without considering any other zone stripe of the RAID system.

9. A redundant array of independent disks (RAID) system for creating a virtual disk, comprising:
a plurality of storage devices, wherein each storage device includes a plurality of zones; and
a controller, electrically connected to the storage devices, for configuring the storage devices into a plurality of zone stripes, wherein each of the zone stripes includes one zone of each of the storage devices, and each zone stripe includes a plurality of data blocks; allocating a first portion of data blocks of each of the zone stripes to form a first virtual sub-disk; allocating a second portion of data blocks of each of the zone stripes to form a second virtual sub-disk, where the second portion of data blocks are different from the first portion of data blocks; and creating the virtual disk according to at least the first virtual sub-disk and the second virtual sub-disk.

10. The RAID system of claim 9, wherein the storage devices are a plurality of physical disks, respectively.

11. The RAID system of claim 9, wherein the data blocks of each zone stripe is divided into N portions, and the controller respectively allocating N portion of data blocks of each of the zone stripes to form N virtual sub-disks, and utilizing the N virtual sub-disks to create the virtual disk.

12. A method for creating a virtual disk on a redundant array of independent disks (RAID) system, the RAID system comprising a plurality of storage devices, each storage device including a plurality of zones, the method comprising:
configuring the storage devices into a plurality of zone stripes, wherein each of the zone stripes includes a zone of each of the storage devices, and each zone stripe includes a plurality of data blocks;
allocating a first portion of data blocks of each of the zone stripes to form a first virtual sub-disk;
allocating a second portion of data blocks of each of the zone stripes to form a second virtual sub-disk, where the second portion of data blocks are different from the first portion of data blocks; and
creating the virtual disk according to at least the first virtual sub-disk and the second virtual sub-disk.

13. The method of claim 12, wherein the storage devices are a plurality of physical disks, respectively.

14. The method of claim 12, wherein the data blocks of each zone stripe is divided into N portions, the method comprising:
respectively allocating N portion of data blocks of each of the zone stripes to form N virtual sub-disks; and
utilizing the N virtual sub-disks to create the virtual disk.
